(19) United States
(12) Patent Application Publication
(10) Pub. No.: US 2021/0254404 A1
(43) Pub. Date: Aug. 19, 2021

(54) Anti-Rotation Clutch Assembly for a Manual Roller Shade

(71) Applicant: Kyle Choi, San Marino, CA (US)

(72) Inventor: Kyle Choi, San Marino, CA (US)

(21) Appl. No.: 16/795,389

(22) Filed: Feb. 19, 2020

(51) Int. Cl. E06B 9/80; E06B 9/42

(52) U.S. Cl. CPC E06B 9/80; E06B 9/42

(57) ABSTRACT

An anti-rotation clutch assembly for a manual roller shade regulates rotational retraction and deployment of a window shade. The clutch assembly provides a rotating wheel subassembly comprising a sprocket plate and an extending shaft that carries a window shade. The sprocket plate supports a cable that transmit rotational motion to shaft. The clutch assembly also includes a rotation biasing device comprising springs having tabs. The springs coil around a stem and fits into the shaft. The spring generates spring tension during rotational motion by shaft to create frictional resistance. The frictional resistance limits the rotational velocity of shaft. The tabs engage edges of the elongated openings in the shaft wall during rotational motion by shaft. This engagement restricts rotational motion by shaft, which limits maximum deployment and retraction of window shade. A fixed base anchors the rotating wheel subassembly to a mounting surface. A protective sleeve covers shaft and springs.

### FIELD OF THE INVENTION

The present invention relates generally to an anti-rotation clutch assembly for a manual roller shade. More so, the present invention relates to a clutch assembly that regulates rotational retraction and deployment of a window shade through use of a rotating wheel subassembly comprising a sprocket plate that supports a cable to transmit rotational motion to a shaft carrying the window shade, and a rotation biasing device comprising at least one spring terminating at tabs and coiled around the shaft; whereby the spring generates a spring tension during rotational motion by the shaft to create frictional resistance to limit rotational velocity of the shaft; and whereby the tabs engage the edges of elongated openings in the shaft wall during rotational motion by the shaft to restrict rotational motion by the shaft, so as to limit maximum deployment and full retraction of the window shade.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, roller blinds, or shades, include a hollow elongated cylinder, around which a flexible panel or fabric wraps around. The roller shade may utilize a flexible shade fabric windingly received on a roller cylinder for raising and lowering the shade fabric by rotating the roller cylinder. In manual roller shades, the rotation of the roller cylinder is provided by an input wheel that receives an input chain for converting a pulling force applied to the input chain into rotation of the input wheel. Manual roller shades include clutches having gear assemblies for transmitting the rotation of the input wheel to the rotation of the cylinder that carries the shade fabric.

Other proposals have involved gears and clutches for window shade assemblies. The problem with these gear assemblies is that they do not prevent excessive rotational speed by the tube carrying the window shade. Also, the extent of rotation in either direction is not always controlled. Even though the above cited gears and clutches for window shade assemblies meet some of the needs of the market, an anti-rotation clutch assembly for a manual roller shade that regulates rotational retraction and deployment of a window shade through use of a rotating wheel subassembly comprising a sprocket plate that supports a cable to transmit rotational motion to a shaft carrying the window shade, and a rotation biasing device comprising springs coiled around the shaft, and having one or more tabs; whereby the spring generates a spring tension during rotational motion by the shaft to create frictional resistance to limit rotational velocity of the shaft; and whereby the tabs engage the edges of elongated openings in the shaft wall during rotational motion by the shaft to restrict rotational motion by the shaft, so as to limit maximum deployment and full retraction of the window shade, is still desired.

### SUMMARY

Illustrative embodiments of the disclosure are generally directed to an anti-rotation clutch assembly for a manual roller shade that regulates rotational retraction and deployment of a window shade. The clutch assembly is configured to regulate rotational retraction and deployment of a manual window shade through use of a rotating wheel subassembly comprising a sprocket plate and an extending shaft defined by a cavity and an elongated opening. The sprocket plate supports a cable that transmit rotational motion to the shaft carrying a window shade. The shaft extends from the sprocket plate, and is defined by a cavity and an elongated opening. A fixed base anchors the rotating wheel subassembly to a mounting surface.

The clutch assembly also includes a rotation biasing device comprising at least one spring terminating at tabs and fitted into the cavity of the shaft. The spring generates a spring tension during rotational motion by the shaft to create frictional resistance. This serves to limit rotational velocity of the shaft. The tabs engage the edges of elongated openings in the shaft wall during rotational motion by the shaft, so as to restrict rotational motion by the shaft to the width of the elongated opening in the shaft wall. This serves to limit maximum deployment and full retraction of the window shade. A protective sleeve covers the shaft and springs.

An anti-rotation clutch assembly, comprises a fixed base comprising a mounting plate and an opposing stem. The clutch assembly also includes a rotating wheel subassembly disposed colinear and adjacent with the base, the rotating wheel subassembly comprising a sprocket plate and a shaft, the shaft being defined by a shaft wall having an elongated opening, the shaft further being defined by a cavity, the sprocket plate mounted on the stem of the base, the shaft receiving the stem of the base, the sprocket plate being operable to transmit a rotational motion to the shaft.

The clutch assembly also includes a sleeve disposed colinear and adjacent with the rotating wheel subassembly, the sleeve being inserted over the shaft of the rotating wheel subassembly, the sleeve further being attached to the stem.

The clutch assembly also includes a rotation biasing device comprising at least one spring terminating at one or more tabs, the spring being coiled around the stem, the tabs being disposed at an orthogonal to the spring, the stem and the spring being fitted into the cavity of the shaft.

Thus, the spring generates a spring tension during rotational motion by the shaft, the spring tension generating frictional resistance to limit rotational velocity of the shaft. And further, the tabs engage the shaft wall during rotational motion by the shaft, the engagement generating frictional resistance to limit rotational velocity of the shaft.

In another aspect, the mounting plate of the base anchors to a flat mounting surface.

In another aspect, the stem terminates at a tapered free end.

In another aspect, the stem has a cylindrical shape.

In another aspect, the sprocket plate of the rotating wheel subassembly is operable to secure a cable, the cable being axially advanced to transmit the rotational motion to the shaft.

In another aspect, the sprocket plate comprises multiple pointed protrusions sized and dimensioned to secure the cable.

In another aspect, the cable comprises a chain bead.

In another aspect, the assembly further comprises a shade, the shade being rolled around the sleeve.

In another aspect, the rotational motion by the shaft rotates the shade.

In another aspect, the shaft wall is defined by an outer surface and an inner surface.

In another aspect, the tabs engage the edges of the elongated openings formed in the shaft wall to limit maximum deployment and full retraction of the shade between deployment and retraction.

In another aspect, the tabs engage the edges of the elongated openings formed in the shaft wall, the engagement restricting the rotational motion of the shaft in both directions.

In another aspect, the tabs engage the edges of the elongated openings formed in the shaft wall during rotational motion by the shaft, the engagement restricting the rotational motion of the shaft to the width of the elongated opening in the shaft wall.

In another aspect, the stem and the spring being fitted into the cavity of the shaft in a snug relationship.

In another aspect, the sleeve is defined by an inner sleeve surface and an outer sleeve surface.

In another aspect, the inner sleeve surface slidably engages the outer surface of the rotating wheel subassembly.

In another aspect, the sleeve has a cylindrical shape.

One objective of the present invention is to create resistance when the rotating wheel subassembly is pulled by the cable in either direction.

Another objective is to prevent the rotating wheel subassembly from spinning too fast.

Yet another objective is to provide a spring that holds the rotating wheel subassembly 110 in place between the fixed base and the sleeve.

Yet another objective is to provide tabs at the ends of the spring to serve as a brace against the inner surface of the shaft wall.

Yet another objective is to provide an inexpensive to manufacture clutch assembly for a window shade system.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a blow-up view of an exemplary anti-rotation clutch assembly, in accordance with an embodiment of the present invention;

FIG. 2 illustrates a perspective view of an exemplary rotation biasing device that regulates rotational velocity and angular limitation of the rotating wheel subassembly, in accordance with an embodiment of the present invention; and

FIGS. 3A and 3B illustrate perspective views of mount plates, where FIG. 3A shows a hook-mounted mount plate, and FIG. 3B a mount plate that fits into an existing tab of another mount plate, in accordance with an embodiment of the present invention.

Like reference numerals refer to like parts throughout the various views of the drawings.

### DETAILED DESCRIPTION OF THE INVENTION

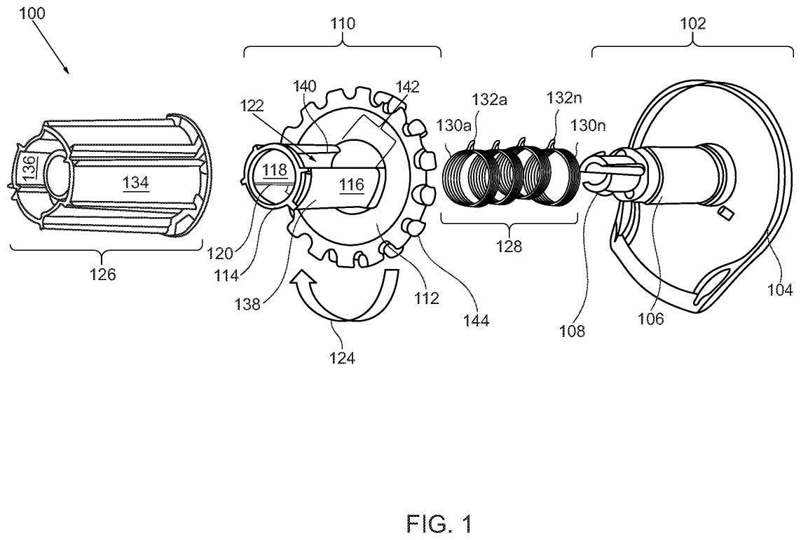

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An anti-rotation clutch assembly 100 for a manual roller shade is referenced in FIGS. 1-3B. The anti-rotation clutch assembly 100, hereafter “clutch assembly 100” is operable with a manual window shade. The clutch assembly 100 regulate rotational velocity and maximum deployment and retraction of the window shade through use of a rotating wheel subassembly 110 that supports a cable used to transmit rotational motion to retract and deploy the window shade.

A fixed base 102 anchors the rotating wheel subassembly 110 to a mounting surface 200.

Looking now at FIG. 1, the clutch assembly 100 utilizes a unique rotation biasing device 128 that regulates rotational velocity and angular limitation of the rotating wheel subassembly 110. This serves to eliminate undesirable rotation of the rotating wheel subassembly 110, and connected window shade. The rotation biasing device 128 includes at least one spring 130a-n having one or more tabs 132a-n at the free ends of the spring. The spring 130a-n is fitted into the cavity of a shaft from the rotating wheel subassembly 110.

When the rotating wheel subassembly 110 rotates during retraction or deployment of the window shade, the spring 130a-n generates a spring tension, which creates frictional resistance. This frictional resistance limits the rotational velocity of the rotating wheel subassembly 110. The springs 130a-n may contract and expand as the frictional resistance and spring tension increase and decrease.

Further, the tabs 132a-n are aligned so as to engage shaft walls of the rotating wheel subassembly 110 during rotation. The tabs 132a-n engage with the shaft walls to restrict rotational motion, and specifically velocity, by the rotating wheel subassembly 110. This limits angular rotation, and thereby the maximum deployment and full retraction of the window shade. A protective sleeve 126 covers the shaft 114 and the springs 130a-n. This helps achieve a primary objective of creating resistance when the cable attached to the rotating wheel subassembly 110 is pulled in either direction, i.e., eliminating undesirable rotation of the window shade.

As FIG. 1 references, the clutch assembly 100 comprises a fixed base 102 that mounts to a mounting surface 200, serving as an anchor for the clutch assembly 100. In some embodiments, the base 102 may include a mounting plate 104 and an opposing stem 106. In one non-limiting embodiment, the stem 106 terminates at a tapered free end 108. In another non-limiting embodiment, the stem 106 has a cylindrical shape.

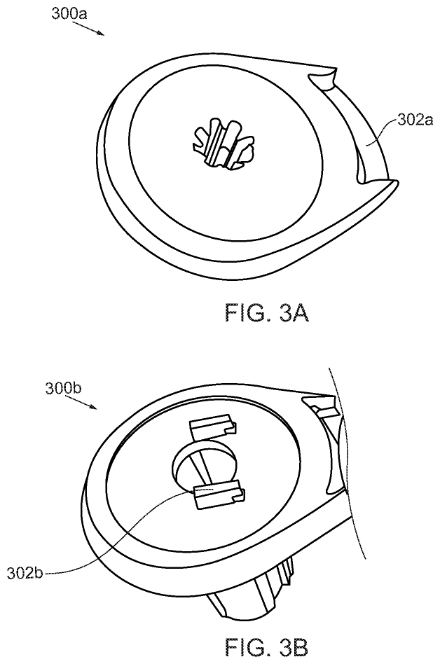

In some embodiments, the mounting plate 104 may be a flat member with fastening holes, or depressions for mounting. The mounting surface 200 may include a wall that borders a window. In this manner, the mounting plate 104 anchors to a flat mounting surface 200. The stem 106 extends perpendicular from the mounting plate 104. FIGS. 3A and 3B illustrate alternative embodiments of the mounting plate that utilize different types of mounting mechanisms. FIG. 3A shows a hook-mounted mount plate 300a with a small bar 302a extending along one edge for receiving a hook. Similarly, FIG. 3B shows a mount plate 300b that fits into an existing tab of another mount plate through a pair of flanges 302b that protrude from the outer face of the mount plate 300b. In yet other embodiments, an adhesive or a magnet could be utilized to anchor the mounting plates.

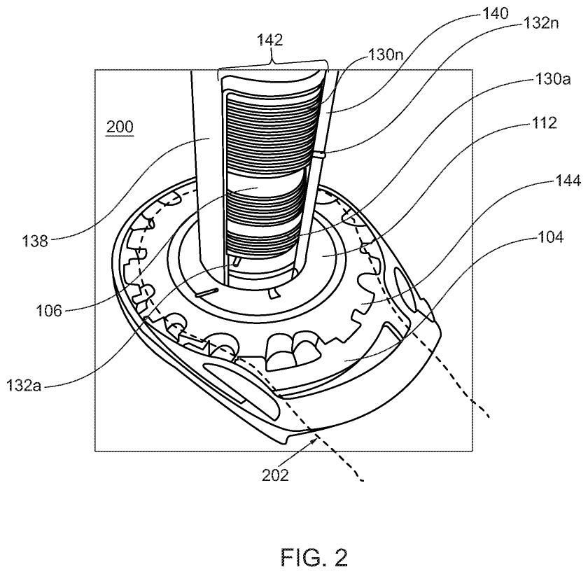

Turning now to FIG. 2, the clutch assembly 100 also provides a rotating wheel subassembly 110, which can be disposed colinear and adjacent with the base 102. The rotating wheel subassembly 110 supports a cable 202 used to transmit rotational motion to retract and deploy the window shade. In this manner, the cable 202 converts a pulling force applied to an input end of the cable into rotation of the sprocket plate 112. In one exemplary use, the cable 202 operates a window shade, which includes a flexible shade fabric windingly received on a roller tube. The cable, such as a guide chain, may then be utilized to raise and lower the shade fabric by rotating the roller tube.

The fixed base 102, as discussed above, works to anchor the rotating wheel subassembly 110 to the mounting surface 200. In some embodiments, the rotating wheel subassembly 110 may include a sprocket plate 112 and a shaft 114. In some embodiments, the sprocket plate 112 of the rotating wheel subassembly 110 is operable to secure the cable 202, as the cable can ride the circumference of the sprocket plate 112. In one embodiment, the cable 202 is advanced along the circumference of the sprocket plate 112, so as to transmit the rotational motion to the shaft 114.

In one non-limiting embodiment, the sprocket plate 112 comprises multiple pointed protrusions 144 sized and dimensioned to secure the cable 202 thereto. In another embodiment, the cable 202 comprises a chain bead. However, any type of resilient cable, or guide chain, may also be used to rotatably advance the sprocket plate 112 and connected shaft 114. In some embodiments, a shade is rolled around the sleeve 126; whereby, the rotational motion 124 by the shaft 114 rotates the window shade.

In some embodiments, the shaft 114 is defined by a shaft wall 138. In one possible embodiment, the shaft wall 138 has an outer surface 116 and an inner surface 118. The shaft wall 138 also forms an elongated opening 142. Further, the shaft 114 is defined by a cavity 122, which may be elongated, so as to receive the stem 106 from the base 102. The cavity 122 is elongated, and may also be tapered. The sprocket plate 112 mounts on the stem 106 of the base 102. The shaft 114 receives the stem 106 of the base 102 in a slidable relationship. In this arrangement, the sprocket plate 112 transmits a rotational motion 124 to the shaft 114.

The clutch assembly 100 also includes a protective sleeve 126 that is disposed colinear and adjacent with the rotating wheel subassembly 110. In one embodiment, the sleeve 126 has an inner sleeve surface 136 and an outer sleeve surface 134. In other embodiments, the sleeve 126 may be slidably inserted over the shaft 114 of the rotating wheel subassembly 110. In one possible embodiment, the inner sleeve surface 136 slidably engages the outer surface 116 of the rotating wheel subassembly 110. The sleeve 126 may also be attached to the stem 106 through a friction fit relationship. In one non-limiting embodiment, the sleeve 126 has an elongated, cylindrical shape. As illustrated, plurality of flutes may extend longitudinally along the outer sleeve surface 134 to create better grip with other accessories.

Turning now to FIG. 2, the clutch assembly 100 provides a unique rotation biasing device 128 that creates the mechanical torque to regulate rotation of the rotating wheel subassembly 110. The rotation biasing device 128 comprises at least one spring 130a-n that is shaped in a coiled configuration. In some embodiments, the spring 130a-n may be coiled around the stem 106 from the base 102. The stem 106 and the spring 130a-n are fitted into the cavity 122 of the shaft 114 in a snug relationship.

Thus, the spring is in contact with the inner surface 118 of the shaft wall 138. As illustrated four springs may be used. The springs may be independent of each other, or connected through a wire or metal cable. In any case, the springs are coiled around the stem, and generate frictional tension with the inner surface 118 of the shaft wall 138.

The spring 130a-n may have along its length, or at its termini, one or more tabs 132a-n. In one non-limiting embodiment, the tabs 132a-n extend orthogonally from the axial disposition of the spring 130a-n. However, in other embodiments, the stem 106 and the spring 130a-n are tightly bound and snugly fitted into the cavity 122 of the shaft 114. However, the spring and stem may also be allowed to rotate freely, or semi-freely inside the cavity 122 of the shaft 114.

Thus, the spring 130a-n generates a spring tension during rotational motion by the shaft. The spring tension generates frictional resistance that limits the rotational velocity of the shaft. This may cause the springs to change in diameter. In essence, the spring may change diameter slightly when the window shade is operated to open/close. For example, as the shaft rotates, the frictional resistance increases as a result of the spring cinching the stem and being compressed into the cavity of the shaft. Conversely, as the rotation ceases, the compression of spring and stem into the shaft cavity is reduced, which allows the spring to contract.

In conjunction with the frictional resistance, the tabs engage the edges 140 of the elongated openings 142 formed in the shaft wall 138 during rotational motion by the shaft. The engagement between the tabs and the edges of the elongated opening 142 serves as a brace to create additional friction to slow the rotational velocity. Additionally, rotational motion of the shaft in both directions (clockwise and counterclockwise) may be restricted from the tabs.

Thus, the tabs 132a-n engage the shaft wall 138 to create friction, and restrict rotational velocity of the shaft. In other embodiments, the tabs engage the edges of the elongated openings formed in the shaft wall to limit maximum deployment and full retraction of the shade between deployment and retraction. In some embodiments, the tabs 132a-n engage the edges of the elongated openings formed in the shaft wall to restrict the rotational motion of the shaft to the width of the elongated opening 142 in the shaft wall 138.

In operation, the cable 202 is pulled from either end of the sprocket plate. The rotational torque creates a rotational motion 124 for the rotating wheel subassembly 110, as torque is transferred to the shaft. This creates frictional resistance due to the spring that is fitted inside the cavity 122 of the shaft 114. Consequently, the rotating wheel subassembly 110 cannot rotate at a fast, uncontrollable velocity. Furthermore, the tabs engage the edges of the shaft wall at the elongated opening thereof.

In conclusion, clutch assembly serves to regulate rotational retraction and deployment of a window shade. The clutch assembly provides a rotating wheel subassembly comprising a sprocket plate and an extending shaft that carries a window shade. The sprocket plate supports a cable that transmit rotational motion to shaft. The clutch assembly also includes a rotation biasing device comprising springs 130a-n having tabs 132a-n. The springs 130a-n coil around a stem and fits into the shaft. The spring generates spring tension during rotational motion by shaft to create frictional resistance. The frictional resistance limits the rotational velocity of shaft 114.

The tabs 132a-n engage edges of the elongated openings in the shaft wall during rotational motion by shaft. This engagement may serve to either reduce rotational velocity by the shaft, or restrict rotational motion by shaft in both directions to the width of the elongated opening. This is effective in limiting maximum deployment and retraction of window shade. In some embodiments, a fixed base anchors the rotating wheel subassembly to a mounting surface. In some embodiments, a protective sleeve, having a larger diameter than the shaft &&′ works to encapsulate the shaft, and the stem and springs. In some embodiments, the sleeve 126 may be an elongated, tapered cylinder adapted to form a snug fit over the shaft 114.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An anti-rotation clutch assembly, the assembly comprising:
a fixed base comprising a mounting plate and an opposing stem;
a rotating wheel subassembly disposed colinear and adjacent with the base, the rotating wheel subassembly comprising a sprocket plate and a shaft, the shaft being defined by a shaft wall having an elongated opening, the shaft further being defined by a cavity, the sprocket plate mounted on the stem of the base, the shaft receiving the stem of the base, the sprocket plate being operable to transmit a rotational motion to the shaft;
a sleeve disposed colinear and adjacent with the rotating wheel subassembly, the sleeve being inserted over the shaft of the rotating wheel subassembly, the sleeve further being attached to the stem; and
a rotation biasing device comprising at least one spring having one or more tabs, the spring being coiled around the stem, the stem and the spring being fitted into the cavity of the shaft,
whereby the spring generates a spring tension during rotational motion by the shaft, the spring tension generating frictional resistance to limit rotational velocity of the shaft,
whereby the tabs engage the shaft wall during rotational motion by the shaft, the engagement generating frictional resistance to limit rotational velocity of the shaft.

2. The assembly of claim 1, wherein the mounting plate of the base anchors to a flat mounting surface.

3. The assembly of claim 1, wherein the stem terminates at a tapered free end.

4. The assembly of claim 1, wherein the stem has a cylindrical shape.

5. The assembly of claim 1, wherein the sprocket plate of the rotating wheel subassembly is operable to secure a cable, the cable being advanced along the circumference of the sprocket plate to transmit the rotational motion to the shaft.

6. The assembly of claim 5, wherein the sprocket plate comprises multiple pointed protrusions sized and dimensioned to secure the cable.

7. The assembly of claim 6, wherein the cable comprises a chain bead.

8. The assembly of claim 1, further comprising a shade, the shade being rolled around the sleeve.

9. The assembly of claim 8, wherein the rotational motion by the shaft rotates the shade.

10. The assembly of claim 1, wherein the shaft wall is defined by an outer surface and an inner surface.

11. The assembly of claim 1, wherein the tabs engage the edges of the elongated openings formed in the shaft wall to limit maximum deployment and full retraction of the shade between deployment and retraction.

12. The assembly of claim 1, wherein the tabs engage the edges of the elongated openings formed in the shaft wall, the engagement restricting the rotational motion of the shaft in both directions.

13. The assembly of claim 1, wherein the tabs engage the edges of the elongated openings formed in the shaft wall during rotational motion by the shaft, the engagement restricting the rotational motion of the shaft to the width of the elongated opening in the shaft wall.

14. The assembly of claim 1, wherein the tabs are disposed at an orthogonal to the spring.

15. The assembly of claim 1, wherein the stem and the spring are fitted into the cavity of the shaft in a snug relationship.

16. The assembly of claim 1, wherein the sleeve has a cylindrical shape.

17. The assembly of claim 10, wherein the sleeve is defined by an inner sleeve surface and an outer sleeve surface.

18. The assembly of claim 17, wherein the inner sleeve surface slidably engages the outer surface of the shaft wall.

19. An anti-rotation clutch assembly, the assembly comprising:
a fixed base comprising a mounting plate and an opposing stem, the stem terminating at a tapered free end;
a rotating wheel subassembly disposed colinear and adjacent with the base, the rotating wheel subassembly comprising a sprocket plate and a shaft, the sprocket plate comprising multiple pointed protrusions, the shaft being defined by a shaft wall having an elongated opening, the shaft wall being defined by an outer surface and an inner surface, the shaft further being defined by a cavity, the sprocket plate mounted on the stem of the base, the shaft receiving the stem of the base the sprocket plate being operable to transmit a rotational motion to the shaft;
a sleeve disposed colinear and adjacent with the rotating wheel subassembly, the sleeve being defined by an inner sleeve surface and an outer sleeve surface, the inner sleeve surface slidably engaging the outer surface of the shaft wall, the sleeve being inserted over the shaft of the rotating wheel subassembly, the sleeve further being attached to the stem; and
a rotation biasing device comprising at least one spring having one or more tabs, the spring being coiled around the stem, the tabs being disposed at an orthogonal to the spring, the stem and the spring being fitted into the cavity of the shaft in a snug relationship,
whereby the spring generates a spring tension during rotational motion by the shaft, the spring tension generating frictional resistance to limit rotational velocity of the shaft,
whereby the tabs engage the edges of the elongated openings of the shaft wall during rotational motion by the shaft, the engagement generating frictional resistance to limit rotational velocity of the shaft to the width of the elongated opening in the shaft wall.

20. An anti-rotation clutch assembly, the assembly consisting of:
a fixed base comprising a mounting plate and an opposing stem, the stem terminating at a tapered free end;
a rotating wheel subassembly disposed colinear and adjacent with the base, the rotating wheel subassembly comprising a sprocket plate and a shaft, the sprocket plate comprising multiple pointed protrusions, the shaft being defined by a shaft wall having an elongated opening, the shaft wall being defined by an outer surface and an inner surface, the shaft further being defined by a cavity, the sprocket plate mounted on the stem of the base, the shaft receiving the stem of the base, the sprocket plate being operable to transmit a rotational motion to the shaft,
whereby the sprocket plate of the rotating wheel subassembly secures to a cable, the cable being advanced along the circumference of the sprocket plate to transmit the rotational motion to the shaft;
a sleeve disposed colinear and adjacent with the rotating wheel subassembly, the sleeve being defined by an inner sleeve surface and an outer sleeve surface, the inner sleeve surface slidably engaging the outer surface of the shaft wall, the sleeve being inserted over the shaft of the rotating wheel subassembly, the sleeve further being attached to the stem; and
a rotation biasing device comprising at least one spring having one or more tabs, the spring being coiled around the stem, the tabs being disposed at an orthogonal to the spring, the stem and the spring being fitted into the cavity of the shaft in a snug relationship,
whereby the spring generates a spring tension during rotational motion by the shaft, the spring tension generating frictional resistance to limit rotational velocity of the shaft,
whereby the tabs engage the shaft wall during rotational motion by the shaft, the engagement generating frictional resistance to limit rotational velocity of the shaft to the width of the elongated opening in the shaft wall.
